(19) United States
(12) Patent Application Publication
(10) Pub. No.: US 2013/0229346 A1
(43) Pub. Date: Sep. 5, 2013

(54) METHOD AND APPARATUS FOR A CAMERA MODULE FOR OPERATING GESTURE RECOGNITION AND HOME APPLIANCE

(71) Applicant: E.G.O. ELEKTRO-GERAETEBAU GMBH, Oberderdingen (DE)

(72) Inventors: Markus Jungbauer, Bruchsal-Obergrombach (DE); Martin Baier, Ettlingen (DE)

(73) Assignee: E.G.O. ELEKTRO-GERAETEBAU GMBH, Oberderdingen (DE)

(21) Appl. No.: 13/785,726

(22) Filed: Mar. 5, 2013

(30) Foreign Application Priority Data
Mar. 5, 2012 (DE) 10 2012 203 457.9

(51) Int. Cl. G06F 3/01

(52) U.S. Cl. CPC G06F 3/017
USPC 345/158

(57) ABSTRACT

A camera module for operating gesture recognition includes a camera, an evaluation unit which evaluates picture data generated by the camera for recognition of an operating gesture from a predefined set of operating gestures, wherein the operating gestures serve for operator control of a home appliance, wherein the home appliance includes a control device for function control separate from the camera module, and an interface for coupling of the camera module with the control device, wherein information according to the recognized operating gesture is transmitted to the control device via the interface.

### CROSS-REFERENCE TO RELATED APPLICATIONS

This application claims priority to German Application No. 10 2012 203 457.9, filed Mar. 5, 2012, the contents of which are hereby incorporated herein in its entirety by reference.

### TECHNOLOGICAL FIELD

The invention relates to a camera module for operating gesture recognition and to a home appliance.

### BACKGROUND

DE 103 61 341 A1 discloses a device for operating a home appliance which comprises means for contactless recognition of gestures and which can be controlled by means of the gestures recognized.

### BRIEF SUMMARY

The object underlying the invention is to provide a camera module for operating gesture recognition (or recognition of operating gestures) and a home appliance which allow a simple and cost-efficient implementable gesture control of home appliances.

The invention achieves the object by means of a camera module and a home appliance.

The camera module for operating gesture recognition comprises: at least one camera, for example one camera or two cameras, for example in each case having a camera chip and associated optics, an evaluation unit, for example in the form of a microprocessor, which evaluates image data generated by the camera for recognition of an operating gesture from a predefined set of operating gestures, wherein the operating gestures serve for operator control of a home appliance, and an interface to a control device of the home appliance separate from the camera module, wherein information regarding the recognized operating gesture or according to the recognized operating gesture is transmitted to the control device via the interface. The camera module preferably includes all components and functions for a gesture operation, and thus forms a gesture control user interface which can be coupled to the control device of the home appliance. Via the interface or the bus between the camera module and the control device of the home appliance, preferably merely basic information in the form of generic operating data is transmitted. This makes it possible that the control device does not need to perform any calculations or the like for recognizing the operating gesture. In the camera module, a number of predefined operating gestures can be stored. Upon recognition of an operating gesture, for example only the identifier of the operating gesture and the X-, Y- and Z-positions of a finger and/or of a hand of an operator who performs the operating gesture are transmitted via the interface. With some operating gestures, there is a contingency that an appropriate correlation of such position data is not possible. The interface may be formed as a serial or parallel data bus.

By means of one of the operating gestures, for example a cooking area or a cooking zone of a cooktop having multiple cooking areas can be selected, and subsequently by means of another of the operating gestures, a desired heating capacity of the cooktop can be set. Furthermore, specific functions of the home appliance can be selected or activated, for example in the form of a program setting, a program parameter setting, etc.

The camera can be a 2-dimensional (2D) camera or a 3-dimensional (3D) camera, for example a so-called time-of-flight camera or a stereo camera.

The camera module can comprise a controllable illuminant or a controllable light source, wherein the evaluation unit synchronizes the illuminant and the camera. For example, the controllable illuminant can be an infrared illuminant, wherein, in the simplest case, controllable refers to adapted to be switched-on and switched-off. The evaluation device can effect the actuation of the illuminant, for example synchronically with a so-called shutter of the camera. This can be advantageous since the illuminant generates a light pulse only at the instant the camera takes a picture.

Alternatively, the illuminant can be provided separate from the camera module, wherein the evaluation unit synchronizes the illuminant and the camera, for example by means of associated control leads and/or by means of a control signal which is transmitted via the interface. On the camera module, a dedicated control output can be provided which allows the connection of the external illuminant.

A unique operating gesture identifier can be assigned to each of the operating gestures from the predefined set of operating gestures, wherein the information correspondent to the recognized operating gesture comprise the assigned operating gesture identifier. The information correspondent to the recognized operating gesture can comprise (three-dimensional) position information of the recognized operating gesture, for example coordinates of a finger and/or of a hand of a user who performs the operating gesture.

The interface can comprise different control leads or control wires, wherein a unique control gesture, in particular exactly one control gesture, from the predefined set of control gestures is assigned to a respective control lead or control wire. For example, the evaluation device can derive a desired operating function from the operating gesture. The operating function can then be signaled to the control device of the home appliance via the associated control lead or control wire. As a result, a key touch control panel can be replaced by the camera module triggering the associated function upon a corresponding operating gesture, for example.

The home appliance comprises: a control device for functional control of the home appliance and a user interface for operator control of the home appliance, wherein the user interface comprises an above-mentioned camera module or is formed by such a camera module.

### BRIEF DESCRIPTION OF THE SEVERAL VIEWS OF THE DRAWINGS

The invention is subsequently described by means of reference to the drawings showing embodiments of the invention. In this case, the figures schematically show in:

FIG. 1 a home appliance according to the invention according to a first embodiment;

FIG. 2 a home appliance according to the invention according to another embodiment; and

FIG. 3 a home appliance according to the invention according to another embodiment.

### DETAILED DESCRIPTION

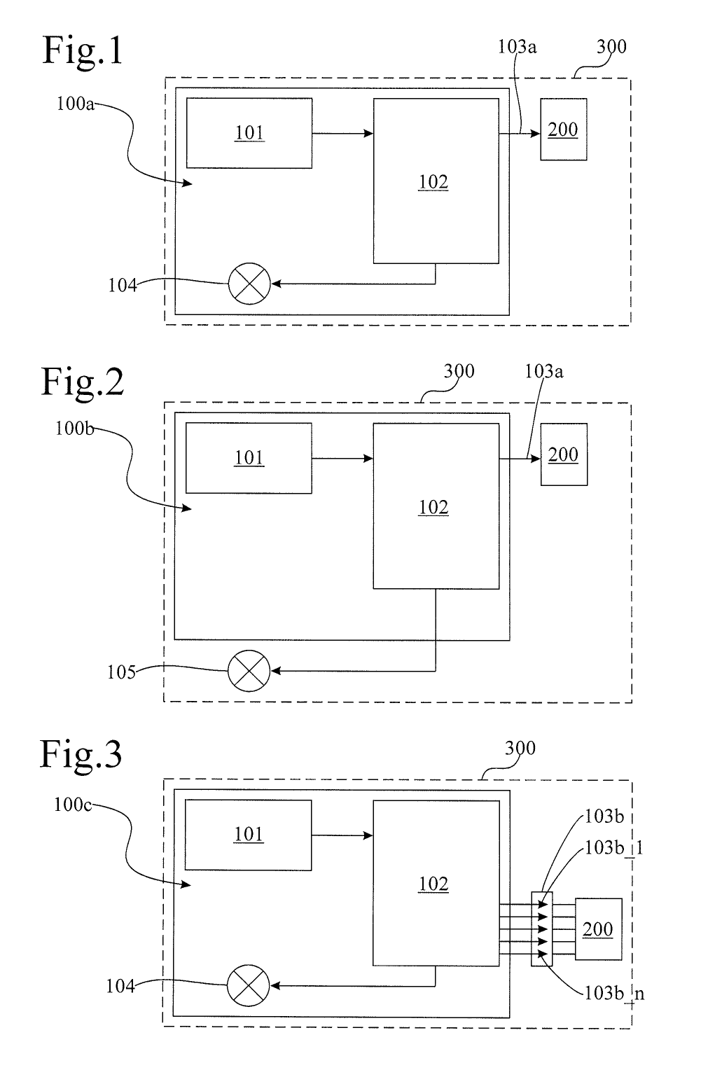

FIG. 1 shows a home appliance 300, for example in the form of an electric stove, a washing machine, a laundry drier etc., having a control device 200, for example in the form of a microcontroller, and a user interface for operator control of the home appliance 300 in the form of a gesture recognition module or a camera module 100a capable of recognizing operating gestures of a user.

The control device 200 serves for function control of the home appliance 300, for example by suitable control of actuators, reading-out of sensors, realizing of control loops, executing of program sequences which can be selected by the user, etc.

The camera module 100a for operating gesture recognition comprises one or two conventional 2D camera(s) or 3D camera(s) 101, an evaluation unit 102, for example in the form of a microcontroller or of a Field Programmable Gate Array (FPGA) which evaluates picture data generated by the camera 101 for recognizing an operating gesture from a predefined set of operating gestures, an illuminant 104 actuated by the evaluation device 102, and a serial interface 103a for coupling of the camera module 100a with the control device 200, wherein the control device 200 comprises a corresponding serial interface not explicitly shown.

The interface 103a can for example be a conventional Universal Asynchronous Receiver Transmitter (UART) interface.

The predefined set of operating gestures serves for operator control of the home appliance 300, wherein the set can comprise the following gestures: pointing by means of the forefinger, closed hand, splayed fingers, fist, fist with thumb on the right side or on the left side, etc. A unique operating gesture identifier is assigned to each operating gesture from the predefined set of operating gestures.

In addition to the actual operating gesture, the camera module 100a recognizes associated position information and/or direction information, for example X-coordinates and Y-coordinates to which a finger of a hand of an operating person points, X-coordinates and Y-coordinates of the hand, and a Z-coordinate of the hand. For determination of the Z-coordinate, a 3D-camera can be used. As an alternative, a (pseudo) Z-coordinate can be determined by means of a 2D-camera by evaluating a size change of the hand. When the hand is recognized by the camera for the first time, a default Z-coordinate can be defined which is then changed in response to a relative size change of the hand detected by imaging.

Upon recognition of an operating gesture by means of the camera module 100a, the associated operating gesture identifier as well as associated position information where required are transmitted to the control device 200 via the interface 103a. The control device 200 correspondingly implements the operating gesture in connection with the additionally transmitted position information, as the case may be, for example by starting a function of the home appliance 300 associated to the gesture, by selecting a cooking area, by changing a desired value, etc.

FIG. 2 shows a home appliance 100b according to the invention according to another embodiment. In this embodiment, a controllable illuminant 105 external in relation to a camera module 100b is provided. The illuminant is synchronized with the camera 101 via a control lead or control wire provided particularly therefor, wherein the evaluation unit 102 actuates the camera 101 and the external illuminant 105 in a synchronized manner.

FIG. 3 shows a home appliance 100c according to the invention according to another embodiment. In the embodiment, the interface 103b comprises n control leads or control wires 103b_1 through 103b_n, wherein to each respective control lead or control wire exactly one operating gesture from the predefined set of equally n operating gestures is assigned. In this case, the evaluation device 102 identifies a desired operating function from the operating gestures and from an associated movement. Then the operating function is signalled to the control device 200 via an associated one of the control leads or control wires 103b_1 through 103b_n. As a result, for example, a key touch control panel can be replaced by the camera module 100c “pressing” the associated operating key in case of a corresponding operating gesture.

Due to the modular configuration of the camera module, a gesture recognition can be connected to diverse controls with little effort. Since the gesture recognition module or the camera module performs the complete evaluation of the picture data delivered by the camera already, the subsequent control can be realized using a more cost-efficient and lower performance processor, or existing controls can be supplemented with a gesture control without any change.

That which is claimed:

1. A camera module for operating gesture recognition comprising:
a camera;
an evaluation unit which evaluates picture data generated by the camera for recognition of an operating gesture from a predefined set of operating gestures, wherein the operating gestures serve for operator control of a home appliance, wherein the home appliance comprises a control device for function control separate from the camera module; and
an interface for coupling the camera module with the control device, wherein information according to the recognized operating gesture is transmitted to the control device via the interface.

2. The camera module according to claim 1, wherein:
the camera is a two-dimensional (2D) camera or a three-dimensional (3D) camera.

3. The camera module according to claim 1, wherein:
the camera module comprises a controllable illuminant, wherein the evaluation unit synchronizes the illuminant and the camera.

4. The camera module according to claim 1, wherein:
the evaluation unit synchronizes the camera and a controllable illuminant provided externally in relation to the camera module.

5. The camera module according to claim 1, wherein:
a unique operating gesture identifier is assigned to a respective operating gesture from the predefined set of operating gestures, wherein the information comprises the assigned operating gesture identifier.

6. The camera module according to claim 1, wherein:
the information comprises position information of the recognized operating gesture.

7. The camera module according to claim 1, wherein:
the interface comprises different control leads, wherein to each respective control lead an operating gesture is assigned from the predefined set of operating gestures.

8. A home appliance comprising:
a control device for function control of the home appliance; and
a user interface for operator control of the home appliance, wherein the user interface comprises a camera module according to claim 1.
